(19) United States
(12) Patent Application Publication
(10) Pub. No.: US 2019/0263522 A1
(43) Pub. Date: Aug. 29, 2019

(54) DRONE DELIVERY SYSTEM HAVING A CRANE WITH DETACHABLE LINE

(71) Applicant: Walmart Apollo, LLC, Bentonville, AR (US)

(72) Inventors: John SIMON, Pembroke Pines, FL (US); Donald R. HIGH, Noel, MO (US); John J. O'BRIEN, Farmington, AR (US); Robert CANTRELL, Herndon, VA (US); Brian MCHALE, Oldham (GB); Justin SCHUHARDT, Montara, CA (US)

(73) Assignee: Walmart Apollo, LLC, Bentonville, AR (US)

(21) Appl. No.: 16/281,667

(22) Filed: Feb. 21, 2019

Related U.S. Application Data
(60) Provisional application No. 62/636,666, filed on Feb. 28, 2018.

(51) Int. Cl. B64D 1/12; B64C 39/02; G08G 5/00

(52) U.S. Cl. CPC B64D 1/12; B64C 39/024; B64C 2201/146; B64C 2201/128; G08G 5/0069

(57) ABSTRACT

An aerial vehicle for delivering a package includes a package deployment system coupled to the aerial vehicle, a package coupled to the securing point, and a monitoring system couple to one of the aerial vehicle or the package deployment system. The package deployment system includes a spool coupled to the aerial vehicle; a lowering line fixedly coupled to the spool at a first end, the lowering line having a bitter end at a second end, a securing point coupled to the lowering line between the first end and the second end, and the bitter end coupled to the aerial vehicle at a securing device. The package deployment system is configured to deliver the package at a delivery location and the securing device is configured to release the bitter end to deliver the package. A method for delivering a package with an aerial vehicle having the package deployment system.

### CROSS REFERENCE TO RELATED APPLICATIONS

This present Patent Application claims priority benefit from U.S. Provisional Patent Application No. 62/636,666 filed on Feb. 28, 2018, the entire content of which is hereby incorporated herein by reference.

### TECHNICAL FIELD OF THE INVENTION

The present application relates to a package deployment system for delivering a package from an aerial vehicle. More specifically, the present application relates to a crane having a detachable line for delivering a package.

### BACKGROUND OF THE INVENTION

Aerial vehicles, such as unmanned aerial vehicles, have become increasingly popular for retail package delivery and for delivery of packages to difficult or remote locations. Currently, delivery of the packages is performed by spooling out a cable or line with the package coupled to a distal end with a claw or other grabbing device. The package is released and the cable is again spooled or left extended as the aerial vehicle returns to a home base, warehouse, or factory location. Therefore, a need exists for improved systems for coupling, retrieving, and re-spooling lines after package delivery.

### BRIEF SUMMARY OF THE INVENTION

According to an embodiment of the present disclosure, an aerial vehicle for delivering a package may include a package deployment system coupled to the aerial vehicle, a package coupled to the securing point, and a monitoring system couple to one of the aerial vehicle or the package deployment system. The package deployment system may include a spool coupled to the aerial vehicle; a lowering line fixedly coupled to the spool at a first end, the lowering line having a bitter end at a second end; a securing point coupled to the lowering line between the first end and the second end; and the bitter end coupled to the aerial vehicle at a securing device. The package deployment system is configured to automatically deliver the package at a delivery location by automatically actuating the securing device to release the bitter end causing the package to descent.

According to an embodiment of the present disclosure, a method for delivering a package with an aerial vehicle may include loading a package on a package deployment system of the aerial vehicle; navigating the aerial vehicle to a delivery location; monitoring a parameter of the aerial vehicle or the package deployment system; releasing, automatically, a bitter end of a lowering line secured to the package based on a first signal indicative of the parameter being within a predetermined threshold; and retracting the lowering line based on a second signal indicative of the package being delivered.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a schematic view of an aerial vehicle, according to an embodiment of the present disclosure;

FIG. 2 shows a perspective view of an aerial vehicle, according to an embodiment of the present disclosure; and

FIG. 3 shows a block diagram of a delivery system for an aerial vehicle, according to an embodiment of the present disclosure.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to an aerial vehicle having a package delivery system. The package delivery system may include a lowering line, a lowering line spool, a monitoring system, a securing device for securing a bitter end of the lowering line to the aerial vehicle, and a securing point for securing to a package to be delivered. The package delivery system may be actuated to deliver the package based on information relayed to the aerial vehicle. The aerial vehicle may send a signal to a component of the package delivery system to activate an actuator associated with the respective component to deliver the package.

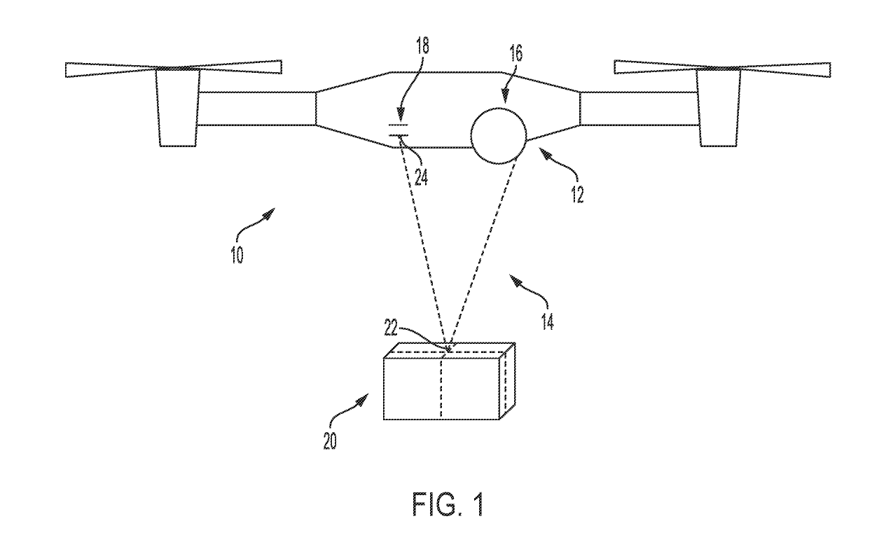

Referring to FIG. 1, a schematic view of an aerial vehicle 10, such as an unmanned aerial vehicle (UAV) is shown. The aerial vehicle 10 may include a package deployment system 12. The package deployment system 12 may include a lowering line 14, a lowering line spool 16, a line tension monitoring system (not depicted), a line bitter end securing device 18, and a spool brake (not depicted). A package 20 may be secured to the lowering line 14 at a securing point 22.

The aerial vehicle 10 may carry the package 20 secured to the lowering line 14 at a securing point 22. The securing point 22 may be a bight, curve, or loop. The securing point 22 may be a handle of a bag, a mesh bag loop, a package harness, a claw, grasping device, or other securing types. The securing point 22 may be any connection that may secure to the package 20 and may allow the lowering line 14 to extend through the connection. The lowering line 14 may be fixedly secured to the spool 16 and may extend through the securing point 22 on the package 20 (e.g. through the handle of the bag, the mesh bag loop, harness, etc.). A bitter end 24 of the lowering line 14 may be secured to the aerial vehicle 10 at the securing device 18. That is, the bitter end 24 of the lowering line 14 may be secured to the aerial vehicle 10 at the securing device 18 and may run through the securing point 22 on the package 20 to the spool 16. Once the aerial vehicle 10 arrives at the delivery location, the aerial vehicle 10 may release the bitter end 24 of the lowering line 14 from the securing device 18 until the package 20 touches down, touches the ground, or approaches a predetermined distance from the ground. The aerial vehicle may actuate the spool 16 to retract the lowering line 14 after delivery of the package 20. As the lowering line 14 is retracted, it may exit or otherwise detach from the securing point 22 on the package 20 and be re-spooled on the spool 16.

The securing device 18 may be a chuck, clamp, vice, spring-loaded clamp, electrical connection, or other mechanical connection that may be actuated to release the bitter end 24 of the lowering line 14. The securing device 18 may receive a signal from the aerial vehicle 10 indicating a particular threshold level has been reached thus signaling an actuator, such as a linear or rotary actuator, to release the securing device 18 and thus release the bitter end 24 of the lowering line 14 and deliver the package 20.

The signal received by the securing device 18 may be indicative of air speed of the aerial vehicle 10, tension on the lowering line 14, distance from a ground or delivery surface, or combinations thereof. Thus, the threshold level may be a particular air speed, tension, distance, height, or combinations thereof. For example, the aerial vehicle may send a signal to the securing device 18 that the aerial vehicle 10 is within a predetermined distance, for example, 10 feet, from the delivery surface. At this point, the aerial vehicle 10 may also monitor air speed and prevent or delay release of the securing device 18 if the air speed of the aerial vehicle 10 exceeds a certain threshold, for example, 5 mph. Additionally, or alternatively, the aerial vehicle 10 may monitor tension on the lowering line 14 with a line tension monitoring system. The line tension monitoring system may indicate when a tension on the lowering line 14 is less than a particular threshold, for example 0.1 lbf before releasing the securing device 18. The aerial vehicle 10 may send a signal to the securing device 18 when any combination of these variables is within the predetermined range. The signal may release the bitter end 24 from the securing device 18.

Any of these monitoring systems may be employed, either alone or in combination, to actuate the release of the securing device 18 and subsequent delivery of the package 20. The monitoring systems previously described may include one or more of each of an altitude sensor, altimeter, a tension monitoring system, load cell, airspeed indicator or gauge, sonar, an optical sensor, Lidar, etc., or combinations thereof. The monitoring systems may be provided on the package 20, any component of the package deployment system 12, or the aerial vehicle 10. The monitoring system may include recognition of a barcode on a delivery location.

The monitoring system may be arranged to determine a distance between the package 20 and the ground surface, delivery surface, a kiosk, or a consumer. The monitoring system may employ Real Time Kinematic (RTK) positioning to determine the distance. RTK positioning may use measurements of the phase of the signal's carrier wave (signal of the UAV and/or the delivery location) in addition to the information content of the signal and rely on a single reference station or interpolated virtual station to provide real-time corrections, providing up to centimeter-level positioning accuracy. Alternatively, or additionally, the monitoring system may employ optical sensors to determine the distance. For example, the aerial vehicle 10 may be equipped to take visual pictures of the delivery location. As the delivery location enlarges in the picture, the aerial vehicle 10 may be programmed to determine a relative position based on the size of the delivery location in the picture. For example, if the delivery location is a kiosk, the aerial vehicle 10 may determine the distance to the kiosk based on the size. When the size of the kiosk in the figure matches the predetermined distance for delivery, the package deployment system 12 may be actuated to deploy the package 20.

The package deployment system 12 may allow the natural weight of the package 20 to pull or move the lowering line 14 toward the delivery surface. The package deployment system 12 may include a drag mechanism or device (not depicted). The drag mechanism may adjust the tension on the lowering line 14 based on a monitoring of movement of the package 20 and/or aerial vehicle 10 and/or based on a monitoring of the tension on the lowering line 14 during the delivery of the package 20. For example, if the package 20 is falling too fast, the drag mechanism may apply tension to the lowering line 14 to reduce the speed of the package 20. The drag mechanism may include an electric motor and a screw or other drag device. The electric motor may be operated to advance or retract the screw based on whether more or less tension, respectively, is desired. The drag mechanism may allow for controlled descent of the package 20.

The package deployment system 12 may include a parachute (not depicted) coupled to the bitter end 24 of the lowering line 14. In operation, when the bitter end 24 is released from the securing device 18, it may begin to fall toward the ground or delivery surface. Where a parachute is included, the parachute may be coupled to the bitter end 24 such that the parachute opens under the force of gravity as the parachute descends. The inclusion of a parachute may cause the rate of decent of the package 20 to be slowed and/or controlled.

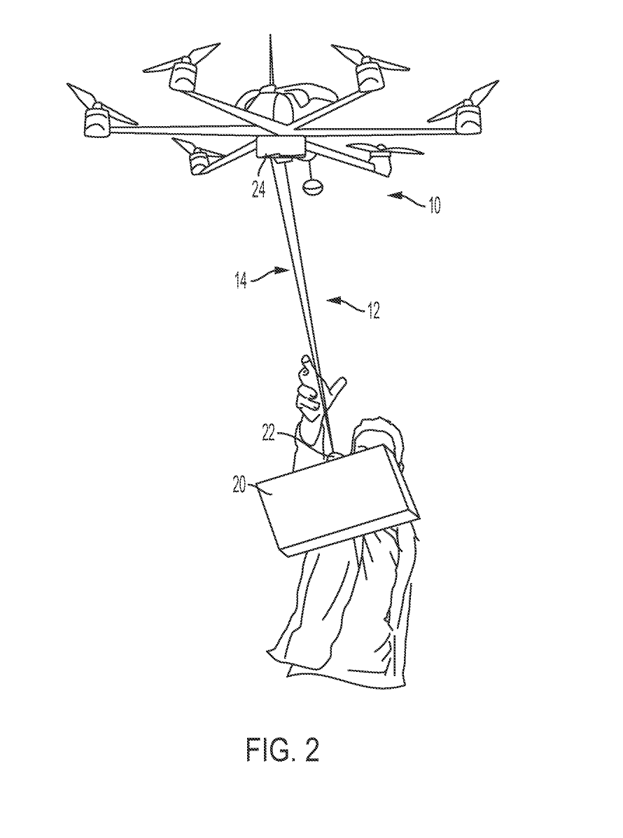

Referring to FIG. 2, operation of the aerial vehicle 10 including the package deployment system 12 is shown. The aerial vehicle 10 may be loaded with the package 20 at a home base or warehouse location. To load the package 20, an operator may first secure a package deployment system 12, including the spool 16 (FIG. 1) to the aerial vehicle 10. The operator may then unspool a predetermined amount of lowering line 14. As the operator unspools the lowering line 14, the operator may thread or maneuver the lowering line 14 through the securing point 22 already formed on or secured to the package 20. Alternatively, the securing point 22 may be previously formed on or coupled to the lowering line 14. Thus, during loading of the package, the securing point 22 may be coupled to the package 20. The operator may then secure the bitter end 24 to the securing device 18 on the aerial vehicle 10. The operator may then initiate flight of the aerial vehicle 10. The aerial vehicle 10 may adjust the length the lowering line 14 extends from the aerial vehicle 10 before and during flight to accommodate for sway and pendulum effect caused by the dangling package 20. The aerial vehicle 10 may navigate to the delivery location. The delivery location may be a consumer, a residential home, a kiosk, etc.

Upon arrival of the aerial vehicle 10, the monitoring system may signal to the package deployment system 12 various parameters, such as the height of the package 20, the tension of the lowering line 14, the speed of the aerial vehicle 10, as has previously been described. If the sensed parameters are within a predetermine threshold (e.g. a predetermined height from the ground or consumer, tension, speed, etc.), the bitter end 24 may be released from the securing device 18 and the package 20 may be allowed to fall or descend to the ground, surface, kiosk, or consumer's arms. The package deployment system 12 may continually or intermittently monitor the tension on the lowering line 14 or the load on the lowering line 14 and send a subsequent signal to the spool 16 indicating the package has been delivered (e.g. when the tension is below 0.1 lbf, indicating the package is no longer suspended from the aerial vehicle 10). The spool 16 may then be actuated to retract the lowering line 14. During retraction, when the securing point 22 is located on the package 20, the lowering line may be removed from the securing point 22, for example, by threading the lowering line 14 through the securing point 22. Alternatively, when the securing point 22 is located on the lowering line 14, the securing point 22 may disconnect from the package 20 and be retracted with the lowering line 14. The securing point 22 may be connected to the package 20 with a quick disconnect or temporary connection such that the connection may be detached from the package 20 and re-spooled with the lowering line 14. Once retracted, the aerial vehicle may return to the base location or warehouse or may continue on to deliver a subsequent package, as will be described to follow.

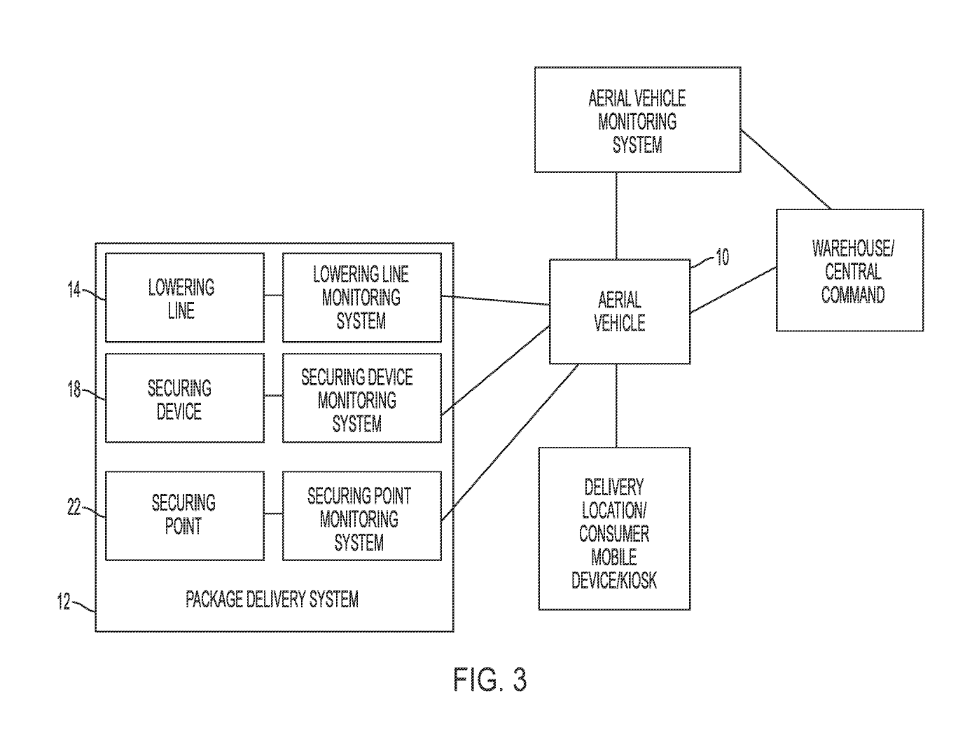

Referring to FIG. 3, a block diagram of an aerial vehicle 10 and package deployment system 12 is depicted. One or more of the individual components of the package deployment system 12 may include monitoring system(s) and/or sensor(s), as previously described. For example, the lowering line 14 may include a tension monitoring system, a load cell at the bitter end, or other monitoring. The securing device 18 and/or securing point 22 may include monitoring system(s) to indicate release or actuation of the respective parts. The monitoring systems may communicate with the aerial vehicle 10. For example, the monitoring systems may transmit and/or receive data or signals to and from the aerial vehicle 10. The monitoring systems may transmit information, data, or other signals to the aerial vehicle 10. The aerial vehicle 10 may process the signal and transmit a signal back to the package delivery system and/or components thereof instructing the component to take a particular action or communicate with another component. For example, the aerial vehicle 10 may instruct the component to actuate, as previously described. Once activated, the monitoring systems may transmit a signal to the aerial vehicle 10 to indicate the new status (e.g., the actuated status) of the respective component and/or may communicate updated data or information to the aerial vehicle. The monitoring systems may communicate real time with the aerial vehicle 10, the consumer, and/or a central command or warehouse.

The aerial vehicle 10 may communicate with the delivery location, consumer mobile device, and/or kiosk to send and/or receive information or data on package delivery, send or receive instructions on deployment, send or receive instructions of storage, and/or send or receive confirmation of package receipt. The aerial vehicle 10 may communicate with the warehouse to send and/or receive information on package delivery and send and/or receive confirmation of package receipt.

The package deployment system 12 may be a single deployment and reusable system. That is, the package deployment system 12 may deliver a single package 20 in a delivery run of the aerial vehicle 10. Once the aerial vehicle 10 is returned to the base location or warehouse, the package deployment system 12 may be secured to another package and the bitter end 24 reattached to the aerial vehicle 10. After delivery of the second package, the process may be repeated as necessary to delivery any or all of the packages housed at the base location or warehouse. In this manner, the aerial vehicle 10 may deliver multiple packages with the same package deployment system 12.

The package deployment system 12 may be modular such that the number of package deployment systems 12 provided on the aerial vehicle 10 may be selected based on the number of packages to be delivered to a particular delivery location or area or on a delivery run of the aerial vehicle 10. Thus, the aerial vehicle 10 may be customized to deliver any number of packages to any number of locations during a package delivery run. For example, the aerial vehicle 10 may be provided with more than one package deployment system 12 such that more than one package 20 may be delivered in a single delivery run of the aerial vehicle 10.

As an example, the aerial vehicle 10 may be provided with two package deployment systems 12. Each of the package deployment systems 12 may be coupled at securing point(s) 22 to two packages 20. The aerial vehicle may navigate to a first delivery location and deliver the first package 20 by releasing the bitter end 24 and the securing point 22 of the first package deployment system 12 in any of the foregoing manners. The first lowering line 14 may be re-spooled. The aerial vehicle 10 may then navigate to a second delivery location and deliver the second package 20 by releasing the bitter end 24 and the securing point 22 of the second package deployment system 12 in any of the foregoing manners. The second lowering line 14 may be re-spooled. The aerial vehicle 10 may navigate to the home base or warehouse to be loaded for the next delivery run.

Where multiple package deployment systems 12 are provided, the aerial vehicle 10 may also be provided with a system for correcting or adjusting for the sway or pendulum effect of the packages due to the sudden loss of weight after delivery of a package. For example, the system may include sensors and/or one or more servos for controlling the movement of the package deployment systems 12. The sensors may relay information on pitch, yaw, and/or roll to the package deployment systems 12 causing the package deployment systems 12 and/or components thereof to move about the aerial vehicle 10 to compensate for the change in weight of the aerial vehicle 10 over the course of the delivery run (e.g., due to delivery of packages) and/or to compensate for the changing center of gravity during flight.

The monitoring system of the aerial vehicle 10 may operate during flight of the aerial vehicle 10. If an obstacle is encountered, for example, if the lowering line 14 is snagged or if the aerial vehicle 10 is otherwise compromised, the monitoring system may send a signal to the securing device 18. The securing device 18 may release the bitter end 24 of the lowering line 14 and drop the package 20. This may allow the obstacle, snag, or other hang up of the aerial vehicle 10 to be overcome and the aerial vehicle 10 may return to the base location or warehouse for repair or restocking of packages. As an example, if the aerial vehicle 10 reaches a certain tension or speed as sensed by the monitoring system, the lowering line 14, spool 16, or the entire package deployment system 12 may be released from the aerial vehicle 10.

The general autonomous nature of the package deployment system 12 may allow for the aerial vehicle 10 to deliver a package 20 to a delivery location without intervention from an operator or consumer. Thus, the package 20 may be delivered to an unmanned kiosk. The kiosk may be programmed to grasp or capture the package 20 based on signals received from the aerial vehicle 10. Additionally, although described for package delivery, the aerial vehicle 10 and package deployment system 12 may be employed for packaged pick up or receipt. For example, an aerial vehicle 10 with package deployment system 12 may navigate to a consumer. The consumer may couple the package 20 to the package deployment system 12 in any of the foregoing manners. This may require the consumer's mobile device or computer is able to communicate with the aerial vehicle 10 and/or the package delivery system 12. When the package 20 is secured to the aerial vehicle, the consumer may instruct the aerial vehicle to take the package 20 to the warehouse and/or a return center, where the package 20 may be received and processed.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

We claim:

1. An aerial vehicle for delivering a package, the aerial vehicle comprising:
a package deployment system coupled to the aerial vehicle, the package deployment system comprising:
a spool coupled to the aerial vehicle;
a lowering line fixedly coupled to the spool at a first end, the lowering line having a bitter end at a second end;
a securing point coupled to the lowering line between the first end and the second end; and
the bitter end coupled to the aerial vehicle at a securing device;
a package coupled to the securing point; and
a monitoring system coupled to one of the aerial vehicle or the package deployment system,
wherein the package deployment system is configured to automatically deliver the package at a delivery location by automatically actuating the securing device to release the bitter end causing the package to descend.

2. The aerial vehicle of claim 1, wherein the monitoring system is configured to monitor a parameter of a component of the package deployment system.

3. The aerial vehicle of claim 2, wherein the component is the lowering line and the parameter is one of tension or load.

4. The aerial vehicle of claim 1, wherein the monitoring system is configured to monitor airspeed of the aerial vehicle.

5. The aerial vehicle of claim 1, wherein the securing device is one of a chuck, a clamp, a vice, a spring-loaded clamp, an electrical connection, or a mechanical connection.

6. The aerial vehicle of claim 1, further comprising a parachute at the bitter end.

7. The aerial vehicle of claim 1, wherein the securing point is one of a handle of a bag, a mesh bag loop, a package harness, a claw, or a grasping device.

8. The aerial vehicle of claim 7, wherein the securing point is releasably coupled to the package, and wherein the securing point is actuated to release the package when a load or a tension on the lowering line is below a predetermined threshold.

9. The aerial vehicle of claim 1, the monitoring system further comprising one or more of an altitude sensor, altimeter, a tension monitoring system, a load cell, an airspeed indicator, an airspeed gauge, sonar, an optical sensor, or Lidar.

10. The aerial vehicle of claim 1, further comprising a second package deployment system, the second package deployment system configured to deliver a second package.

11. A method for delivering a package with an aerial vehicle, the method comprising:
loading a package on a package deployment system of the aerial vehicle;
navigating the aerial vehicle to a delivery location;
monitoring a parameter of the aerial vehicle or the package deployment system;
releasing, automatically, a bitter end of a lowering line secured to the package based on a first signal indicative of the parameter being within a predetermined threshold; and
retracting the lowering line based on a second signal indicative of the package being delivered.

12. The method of claim 11, wherein loading the package on the package deployment system includes securing the lowering line through a securing point on the package and then securing the bitter end to securing device on the aerial vehicle.

13. The method of claim 11, wherein monitoring the parameter further comprises monitoring one of airspeed of the aerial vehicle, distance between the package and a delivery surface, or tension on the lowering line.

14. The method of claim 11, wherein retracting the lowering line includes retracting a securing point coupling the lowering line to the package.

15. The method of claim 11, wherein the parameter is a distance between the package and a delivery surface.

16. The method of claim 11, wherein the second signal is indicative of a tension of the lowering line being below a predetermined level.
